(19) United States
(12) Patent Application Publication
(10) Pub. No.: US 2024/0426761 A1
(43) Pub. Date: Dec. 26, 2024

(54) Method and optical system for imaging optical defect

(71) Applicant: john le, woodbury, MN (US)

(72) Inventor: john le, woodbury, MN (US)

(21) Appl. No.: 18/340,849

(22) Filed: Jun. 24, 2023

(51) Int. Cl. G01N 21/88; G01N 21/958

(52) U.S. Cl. CPC G01N 21/8806; G01N 21/8851; G01N 21/958; G01N 2021/8848

(57) ABSTRACT

Aspects of the disclosure provide an optical system and a method for optical defect inspection. An optical system includes a first point light source, a first detector, a first holder to hold an optical device under test (DUT). The optical further include at least one of of following, a second point light source, a second detector. A method of the present disclosure includes a first step of emitting light from a point light source onto a DUT having a first and a second surface, a second step of capturing a first intensity image(s) of a transmitted light through the DUT onto a first detector, a third step of capturing a second intensity image(s) of a reflected light from the DUT onto a second detector, and a fourth step of processing the first and second intensity image(s) to visualize a defect originated from the first and second surfaces.

### TECHNICAL FIELD

The present disclosure relates to optical defect inspection technology.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Polarized catadioptric optics systems, also known as pancake optics, are an emerging solution for virtual reality (VR) head-mounted displays (HMD). Manufacturing pancake optics, which involves e.g. 3D laminated reflective polarizer mirror, are challenging due to polymer thin film defects, lamination defects, injection molded lens defects, etc. A method for analyzing optical defects is needed.

### SUMMARY

Aspects of the disclosure provide an optical system and a method for optical defect inspection. An optical system for optical defect inspection includes a first point light source, a first detector, and a first holder to hold an optical device under test (DUT), wherein the first holder includes an aperture stop which is configured as an opening to limit light to within an area of the DUT. The optical further includes one of the following: a second point light source, and a second detector, wherein the point light source is positioned not to block the light coming from DUT onto the detector. The point light source is a light source emitted from an area, wherein the width of the area is less than 0.4 mm. The detector is a physical screen wherein the image on the screen is captured by a camera.

Aspects of the disclosure provide a method for optical defect inspection comprised of emitting light from a first point light source to an optical device under test (DUT), projecting a first transmitting light through the DUT onto a first detector, capturing a first image projected onto the first detector, emitting light from a second point light source to a DUT, projecting a first reflecting light from the DUT onto a second detector, capturing a second image projected onto the second detector.

In an embodiment, a point source includes a polarizer that polarizes the light emitting from the point source.

In an embodiment, a detector includes a polarizer that polarizes the light projecting onto the detector.

In an embodiment, the optical system includes a first point light source, a second point light source, and a first detector.

In an example, the optical system includes a first point light source, a first detector, and a second detector.

In an embodiment, the optical system includes a first point light source, a second point light source, a first detector, and a second detector.

In an embodiment, the optical system further includes a first aperture stop and a second aperture stop which is configured as an opening to limit light in a DUT to an area within the DUT.

In an embodiment, the optical system further a converging lens or a diverging lens to control light emission from the point light source.

In an embodiment, the method includes emitting light from a first point light source to a DUT, projecting a first transmitting light through the DUT onto a first detector, capturing a first image projected onto the first detector, emitting light from a second point light source to a DUT, projecting a first reflecting light from the DUT onto the second detector, capturing a second image projected onto the second detector, wherein the second detector is also the first detector.

In an example, the method includes emitting light from a first point light source to a DUT, projecting a first transmitting light through the DUT onto a first detector, capturing a first image projected onto the first detector, emitting light from a second point light source to a DUT, projecting a first reflecting light from the DUT onto the second detector, capturing a second image projected onto the second detector, wherein the second point light source is also the first point light source.

In an embodiment, the method includes emitting light from a first point light source to a DUT, projecting a first transmitting light through the DUT onto a first detector, capturing a first image projected onto the first detector, projecting a first reflecting light from the DUT onto a second detector, capturing a second image project onto the second detector, emitting light from a second point light source to a DUT, projecting a second transmitting light through the DUT onto a first detector, capturing a third image projected onto the first detector, projecting a second reflecting light from the DUT onto a second detector, capturing a fourth image project onto the second detector.

In an embodiment, the method includes processing an image captured by the detector. Processing an image includes correcting flat field, correcting distortion, detecting edge, analyzing a derivative of an image, and applying band-pass filter.

In an embodiment, the method includes capturing and processing multiple images to characterize defects.

In an embodiment, the method includes processing more than one image from more than one detector.

### BRIEF DESCRIPTION OF THE DRAWINGS

Further features, the nature, and various advantages of the disclosed subject matter will be more apparent from the following detailed description and the accompanying drawings in which:

FIG. 1 shows a schematic of an optical system in a side view according to some embodiments of the disclosure.

FIG. 2 shows an example of an optical system in a side view according to some embodiments of the disclosure.

FIG. 3 shows an example of a defect image provided by the optical system shown in FIG. 2 according to some embodiments of the disclosure.

FIG. 4 shows an example of a defect image provided by the optical system shown in FIG. 2 according to some embodiments of the disclosure.

FIG. 4 shows a flow chart of an example of an inspection method provided by the optical system shown in FIG. 2 according to some embodiments of the disclosure.

### DETAILED DESCRIPTION OF EMBODIMENTS

An optical system can include a point light source to provide a spherical wave front incident light, an optical device under test (DUT) to reflect or transmit the incident light and a detector to capture an image of reflected or transmitted light from the DUT. The DUT can change a wavefront shape emitted from a point source, e.g. the wavefront change from convex to concave. The detector can capture the spatial light intensity for wavefront change. A defect in the DUT could act as an object that scatters light. The detector can capture an image of the defect as a shadow, and the size of the shadow tends to increase with a decrease in the source-to-object distance (SOD), an increase in source-to-detector distance (SDD), or an increase in object-to-detector distance (ODD).

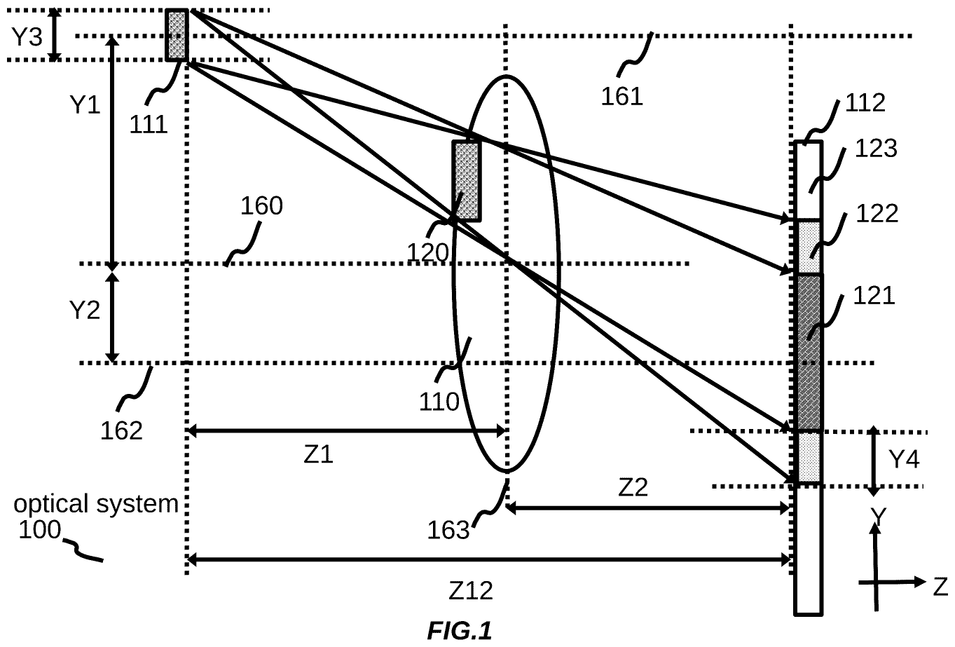

FIG. 1 shows an optical system (100) in a side view according to some embodiments of the disclosure. The optical system (100) includes a point light source (111) having light emitted from an area of (Y3) width, a DUT (110) having a defect object (120) that scatters the incident light at a SOD (Z1), a detector (112) at an ODD (Z2) having an object image appeared as a shadow (121) with a partially shaded region (122) having the width of (Y4) in a bright background (123). The magnification of the optical system can be determined as a ratio of the object image size to the defect object size. For a perfect point light source, the with (Y3) of the light emitting area approaches zero, and the partially shaded region (122) approaches zero, and the defect object image detected at the detector may appear sharp. For a point light source emitted from an area, the partial shade area width (Y4) can be approximated as Y3*(ODD/SOD).

Referring to FIG. 1, for the optical system to detect a small defect object, the optical system can have a point light source emitted from a smaller area, with a DUT closer to the light source and farther from the detector. The most common point light source is the light source emitted out of a pinhole. A point light source can be a light source emitted from an optical fiber. For a point light source using an optical fiber, the light emitting area is the fiber core size, which ranges from a few microns to millimeter. The numerical aperture of the optical fiber is considered to provide wider angular output. As the optical fiber core size is getting smaller, it may take a longer time for the detector for capturing good signal-to-noise images. The object-to-detector distance (ODD) can be increased at the trade-off of the compactness of the optical system.

An optical system can detect a wavefront distortion caused by a defect in the DUT. A defect on the optical surface of DUT can act like an optical defect surface zone with optical power and an effective focal length, which focal length can be negative or positive depending on surface zone curvature. The optical power of the defect surface zone can be refractive or reflective. As a light is reflected from or transmitted through the defect surface zone, the detector can capture an image of the defect as a brighter spot if the focal length of the defect surface zone is close to the object to detector distance (ODD), as a darker spot if the focal of the defect surface zone is far from ODD. The derivative of the captured image can be processed, e.g. analyzing the derivative of the image, to help to visualize an edge of the defect in the captured image.

The optical system can include an aperture stop which is configured as an opening to limit light to a DUT within an area within the DUT. In some cases, a DUT may have a complex surface profile, e.g., wave shape including a convex zone and concave zone. The reflected and transmitted wavefront from such wave shape DUT may have overlapped zones at the detector. And it may be less obvious if a defect originated in the convex zone or the concave zone of such wave shape DUT. By having the aperture stop over a certain area of the DUT, it may help to image a defect in that area.

The optical system can include other optical components (s). it may include a polarizer that polarizes the light emitting from the point source. Or a detector includes a polarizer that polarizes the light projecting onto the detector. The detector can be a physical projection screen wherein the image on the screen is captured by a camera. A polarization camera can be used to capture the polarization image. The projection screen can be a white opaque diffusing screen or can be a scattering metal mirror. The optical system can include a refractive optical element(s) (e.g., a lens) that refract light. A converging lens or a diverging lens may help to control the light emission profile from the point light source.

The optical system can include a DUT. A DUT can be a transparent window having a first surface and a second surface. In case the optical system detects an optical defect in such the transparent DUT in either a reflective mode (where the reflective wavefront from the DUT is captured by the detector) or in a transmissive mode (where the transmissive wavefront from DUT is captured by the detector), it may less certain to know if the optical defect is located on the first surface, or on the second surface, or inside the DUT. It may be helpful to further coat the DUT with reflective coating and to use an optical system to image in reflective mode to determine the surface location of the defect since the reflective wavefront is dominated by the reflection of the front surface (versus the back surface) for highly reflective DUT.

In an embodiment, a DUT can have a polarization component, e.g., a reflective polarizer is disposed on the surface of the DUT. In this case, the DUT has a first surface being a reflective polarizer. As a unpolarized light is incident upon the first surface, the light reflected from the first surface and the second surface will be reflected onto the first detector and the light transmitted through the DUT will be transmitted to the second detector. However, since the reflection intensity from the first surface is significantly higher than from the second surface, the image captured by the first detector can represent the wavefront image from the first surface, and a defect detected by the first detector is likely located on the first surface. The image captured by the second detector can represent the wavefront image passing through both the first and second surface, and a defect detected by the second detector is likely located on either the first or second surface. A defect located on the second surface can be determined by removing the defect detected by the first detector from the defect detected by the second detector.

In an embodiment, a DUT can have a polarization component, e.g., a reflective polarizer is disposed on the surface of the DUT. In this case, the DUT has a first surface being convex or plano, and the second surface being convex where the first surface is a reflective polarizer. As an unpolarized light is incident upon the first surface, light reflected from the surface surface and the second surface will be reflected onto the detector. Assuming the ODD is about the focal length of the second reflective surface, then, the reflection of the second surface will focus on a spot of high intensity. So, even if the detector receives more light reflective from the first surface, the second surface reflection will appear as a bright spot on the detector. By having the polarized light incident upon the first surface and the polarization axis of incident light orthogonal to the polarization axis of the reflective polarizer on the first surface, the reflective light from the DUT to the detector would be predominantly from the first surface.

Polarized catadioptric optics systems, also known as pancake optics, are an emerging solution for virtual reality (VR) head-mounted displays (HMD). Manufacturing pancake optics can involve 3D laminated reflective polarizer (RP) over injected molded plastic lens. A defect in a 3D laminated RP lens can include a dent or a bump defect in the RP mirror surface, where the dent or bump defect size can range from a ten micron to a few hundred microns, a wrinkle defect in the RP mirror surface where the wrinkle defect can be characterized a fold or a high curvature area on RP surface, a wavy surface defect in RP mirror where the wavy surface defect can be characterized as a surface having an orange peel appearance. The wrinkle and the wavy surface defect can be featured as a line or a periodic structure with a peak-to-valley on the order of a few nanometers to a micrometer, and a period of the periodic structure can be on the order of 0.01 mm to a few mm.

A defect in injection molded lenses can include a defect due to the molding insert tool. The molding insert tool is typically fabricated by a diamond-turning machining process. Without proper polishing or maintenance, the insertion tool may have a machining tool mark, which feature may have a peak-to-valley on the order of a few nanometers to a micrometer, a period of the periodic structure can be on the order of 0.01 mm to a few mm. The molded lens may have a beam-splitter (BS) coating which partially reflects or transmit light in a predetermined wavelength.

In an embodiment, the optical system includes a first point light source, a second point light source, and a first detector. The first detector can detect both reflective wavefront and transmissive wavefront from a DUT having a first and a second surface where the first surface is more reflective than the second surface. The transmissive and reflective wavefront from a DUT can be originated from the first and the second point light source, respectively. The detector captures a first image from the transmission wavefront and a second image from the reflective wavefront. The first image includes a defect imaging of the first and second surfaces, and the second image includes a defect imaging of the first surface. Image processing of the first and the second image can characterize the defect characteristics of the first and the second surface individually.

In an embodiment, the optical system includes a first point light source, a first detector, and a second detector. The first detector can detect a reflective wavefront and the second detector can detect a transmissive wavefront from a DUT having a first and a second surface where the first surface is more reflective than the second surface. The transmissive and reflective wavefront from a DUT can be originated from the first point light source. The first detector captures the first image from the reflective wavefront, and the second detector captures the second image from the transmissive wavefront. The second image includes a defect imaging of the first and second surfaces, and the first image includes a defect imaging of the first surface. Image processing of the first and the second image can characterize the defect characteristics of the first and the second surface individually.

In an embodiment, the optical system includes a first point light source, a second point light source, a first detector, and a second detector. The first detector can detect the first reflective wavefront from a first surface of a DUT. The second detector can detect a second reflective wavefront from a second surface of a DUT. The first and second surfaces of the DUT are highly reflective. The first and second reflective wavefront from a DUT can be originated from the first and the second point light source, respectively. The first detector captures the first image from the first wavefront, the second detector captures the second image from the second wavefront. The first image includes a defect imaging of the first, and the second image includes a defect imaging of the second surface. Image processing of the first and the second image can characterize the defect characteristics of the first and the second surface individually.

In an embodiment, the optical system includes an imaging processor. The imaging processor can be a computer equipped with imaging processing software. The imaging processing software can process the captured image, e.g., transforming the image to correct for distortion, enhancing the edge detection of a visual defect in the image, counting defects, classifying a defect into a category, and mapping a defect onto a lens location map.

In an embodiment, the optical system includes a detector. The detector is configured as a projection screen and an image projected onto the projection screen is captured by a camera. The camera or the detector can capture and process multiple images.

In an embodiment, the optical system includes a physical arrangement of a detector, a DUT, and a point light source, and other detectors or other point light source or other DUT. The physical arrangement of the mentioned detector, point light source, and DUT is configured so that a point light source may not obstruct a light ray originating from the other point light source passing through the DUT and landing on the detector.

Examples of optical systems according to some embodiment of the disclosure are modeled using Zemax OpticStudio® software.

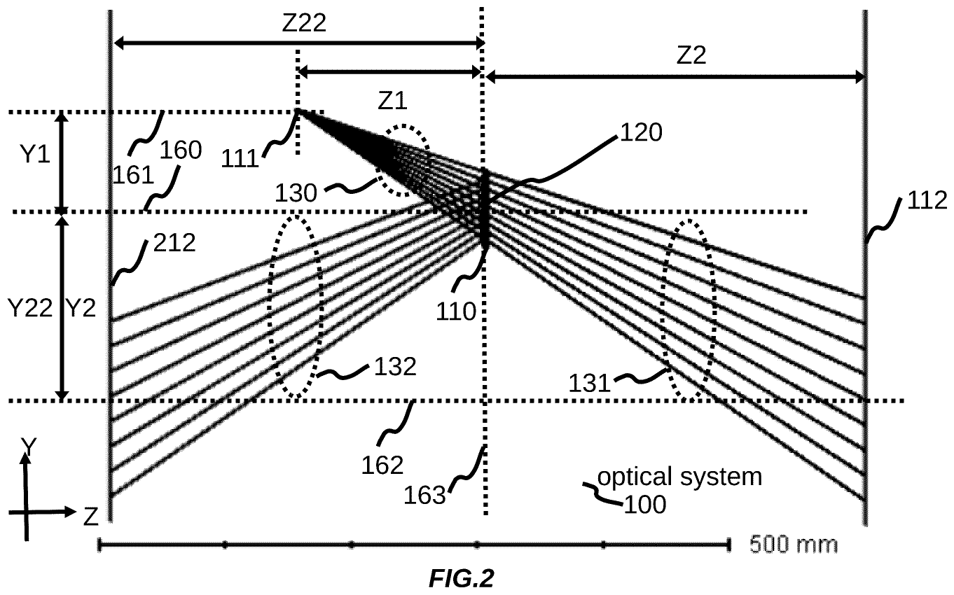

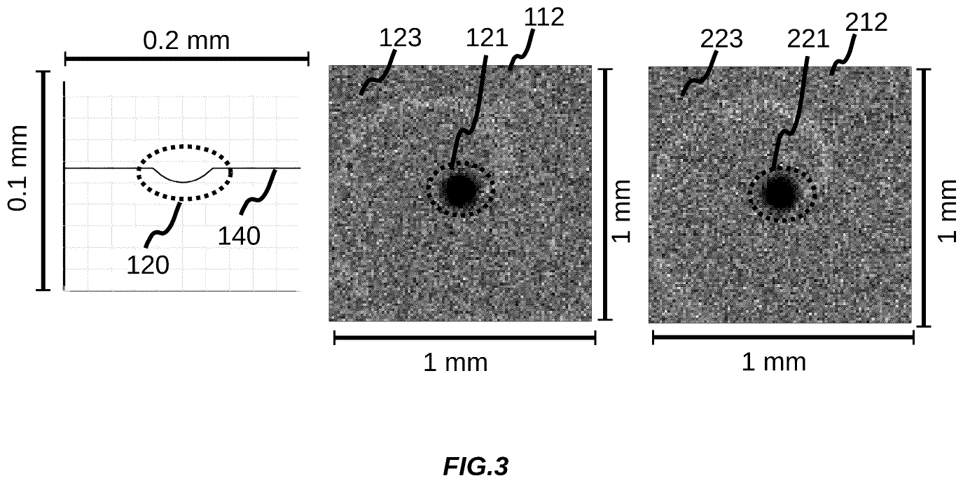

FIG. 2 shows an example of an optical system (100) (e.g. a lens defect inspection system) in a side view according to some embodiments of the disclosure. The optical system (100) includes a first point light source (111) having light emitted from an area of (Y3) width (not shown), a DUT (110) having a first defect object ((120) shown in FIG. 3 or (520) shown in FIG. 5) that scatter the incident light at a first SOD (Z1), a first detector (112) at a first ODD (Z2) having a projection image of the first defect object. The optical axis of the DUT (110) is the z-axis (161) and y-axis (163). Relative to the DUT, the first point source and first detector at the distances (Z1, Y1) or (150 mm, 80 mm) and (Z2, Y2) or (300 mm, 150 mm) respectively. The optical system (100) also includes a second detector (212) at a second ODD (Z22) having a second projection image of the second defect object. Relative to the DUT, the second detector at the distances (Z22, Y22) or (300 mm, 150 mm). A first point light source (111) emits an incident light ray (130) onto the DUT (110). The incident ray (130) transmits through the DUT (110) and resulted as a transmitted ray (131), and the incident ray (130) reflect from the DUT (110) and results as a reflected ray (132). The first detector (112) and second detector (212) capture an intensity image of the transmitted ray (131) and the reflected ray (132) respectively.

FIG. 2 shows an example of an optical system (100) (e.g. a lens defect inspection system) in a side view according to some embodiments of the disclosure. The optical system (100) wherein the first and second detectors are a first and a second white diffusing projection screen and an image that appeared on the first and second screen is captured by a first and a second camera (not shown). The optical system includes a physical arrangement of the first and second detector, the DUT, and the point light source so that the first point light source may not obstruct a light ray reflected from the DUT onto the second detector, and there are rooms (not shown) for the first and second camera to occupy to capture an image on the first and second detector.

FIG. 2 shows an example of an optical system (100) (e.g. a lens defect inspection system) in a side view according to some embodiments of the disclosure. The optical system (100) includes a DUT and a first point light source having light emitted from an area of (Y3) width. The DUT has a first surface (140) and a second surface, wherein the first surface is a reflective polarizer surface, e.g., a laminated RP film on an optical window, and the second surface is bare. The first surface is more reflective than the second surface.

FIG. 3 shows an example of a defect image provided by the optical system (100) shown in FIG. 2. The optical system (100) includes a DUT. a first detector (112) having a projection image of the first defect object appeared as a first defect shadow (121) in a bright background (123), a second detector (212) having a second projection image of the second defect object appeared as a second defect shadow (221) in a bright background (223). The DUT is a molded optical window made of polymethyl methacrylate (PMMA) having a window thickness of 3 mm and semi-diameter of 30 mm. The first surface of the DUT (110) has a first defect object (120). FIG. 3. shows the first defect object as a bump with a radius of curvature of 50 micrometers, and a diameter of 50 micrometers, positioned at the center of the first surface (140) of the DUT (110) (not shown), as an example of a laminated bump defect. FIG. 3. shows a geometric image analysis done using Zemax software, with e.g., a setting of 10\hat{ }9 rays tracing. For a point source having an area width (Y3) of 25 micrometers, the first detector (112) shows a projection image of the first defect object (120) that appeared as a first defect shadow (121) in a bright background (123), the second detector (212) shows a projection image of the first defect object (120) appeared as a second defect shadow (221) in a bright background (223).

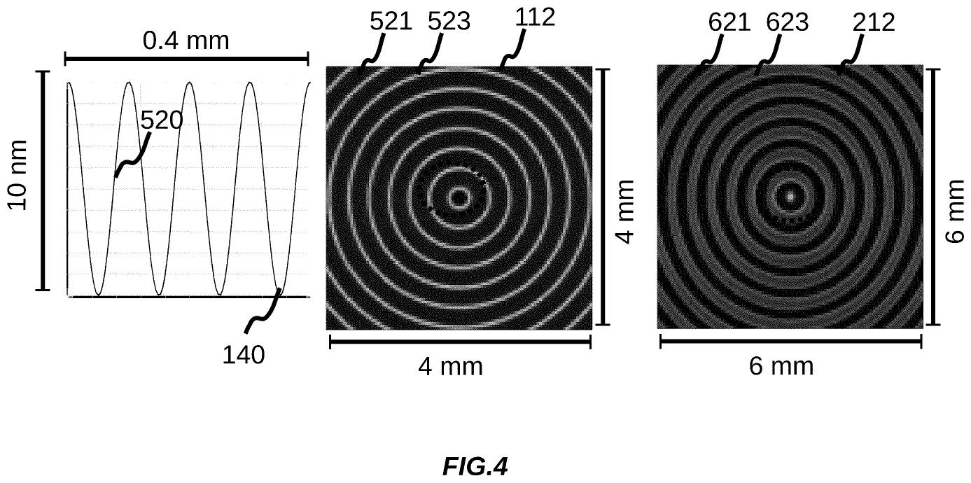

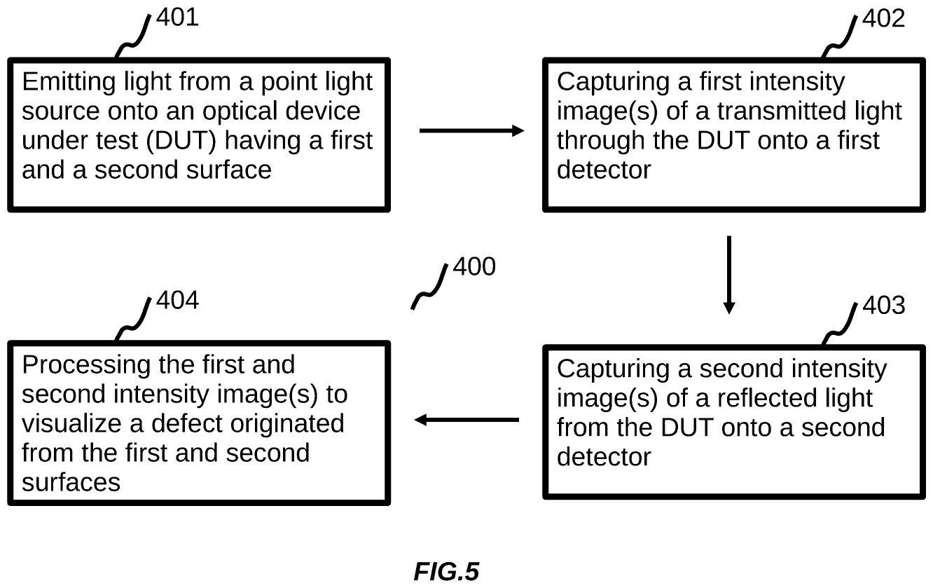

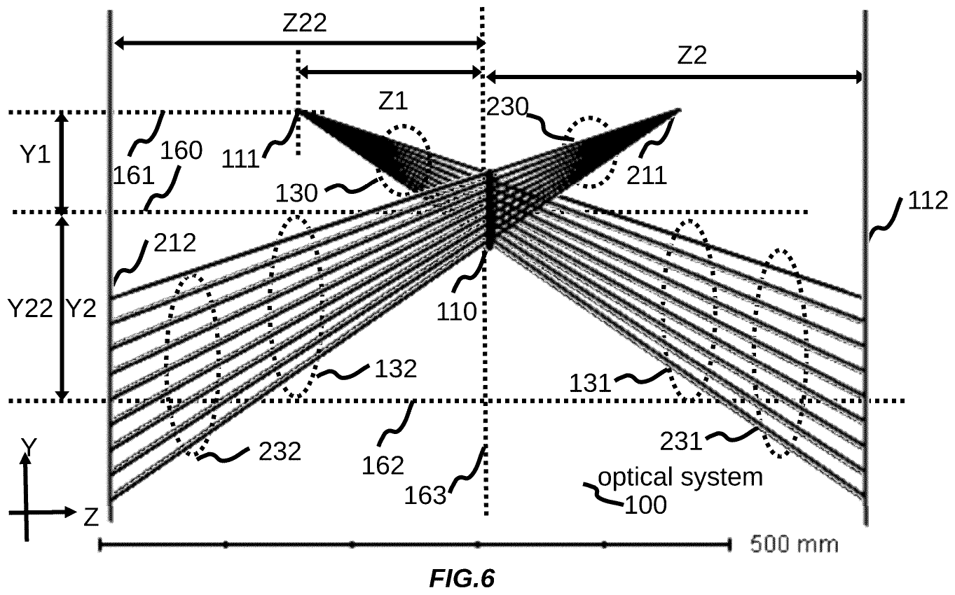

FIG. 4 shows an example of a defect image provided by the optical system (100) shown in FIG. 2. The optical system (100) includes a DUT. a first detector (112) having a projection image of the first defect object appeared as a first defect shadow (521) in a bright background (523), a second detector (212) having a second projection image of the second defect object appeared as a second defect shadow (621) in a bright background (623). The DUT is a molded optical meniscus lens made of polymethyl methacrylate (PMMA) having a lens thickness of 3 mm, and semi-diameter of 30 mm. The first surface (140) of the DUT (110) is a convex surface with a radius of curvature of 400 mm. The second surface of the DUT (110) is a concave surface with a radius of curvature of 400 nm. The first surface (140) has a first defect object (520). FIG. 4. shows the first defect object as a wavy periodic surface with a peak-to-valley amplitude of 10 nm, and the period of 0.1 mm on the first surface (140) of the DUT (110) (not shown), as example of an orange peel or a tool marked surface. FIG. 4. shows a geometric image analysis done using Zemax software, with e.g., a setting of 10\hat{ }9 rays tracing. For a point source having an area width (Y3) of 25 micrometers, the first detector (112) shows a projection image of the first defect object (520) that appeared as a first defect shadow (521) in a bright background (523), the second detector (212) shows a projection image of the first defect object (520) appeared as a second defect shadow (621) in a bright background (623).

Referring to FIG. 2, the example of an optical system (100) can be fabricated from the following parts, according to some embodiments of the disclosure. The detector is configured as a projection screen, e.g., white #2447 cast acrylic sheet (available at professionalplastics.com), and a camera e.g. GS3-U3-51S5M-C 2/3″ FUR monochrome camera (available at edmundoptics.com) with Kowa LM6JC—6 mm F/1.4 lens (available at kowa-usa.com). The point source is configured as an optical fiber coupled LED, e.g., MCWHF2 fiber-coupled LED with M14L01—Ø50 μm fiber patch cable (available at thorlabs.com). The camera and light source are controlled by a computer equipped a camera acquisition/vision/image processing software, e.g., Labview (available at ni.com). The optical system may include a robot to provide automation for a DUT placement. The optical system may include a black housing enclosure to control ambient light.

FIG. 5 shows an example of a method for an optical defect inspection provided by an optical system (100) (e.g. a lens defect inspection system) according to some embodiments of the disclosure. A method of the present disclosure (400) includes a first step (401) of emitting light from a point light source onto an optical device under test (DUT) having a first and a second surface, a second step (402) of capturing a first intensity image(s) of transmitted light through the DUT onto a first detector, a third step (403) of capturing a second intensity image(s) of reflected light from the DUT onto a second detector, and fourth step (404) of processing the first and second intensity image(s) to visualize a defect originated from the first and second surfaces.

FIG. 6 shows an example of an optical system (100) (e.g. a lens defect inspection system) in a side view according to some embodiments of the disclosure. Similarly to FIG. 2, the optical system (100) includes a first point light source (111) having light emitted from an area of (Y3) width (not shown), a DUT (110) having a first defect object ((120) shown in FIG. 3 or (520) shown in FIG. 5) that scatter the incident light at a first SOD (Z1), a first detector (112) at a first ODD (Z2) having a projection image of the first defect object. The optical axis of the DUT (110) is the z-axis (161) and y-axis (163). Relative to the DUT, the first point source and first detector at the distances (Z1, Y1) or (150 mm, 80 mm) and (Z2, Y2) or (300 mm, 150 mm) respectively. The optical system (100) also includes a second detector (212) at a second ODD (Z22) having a second projection image of the second defect object. Relative to the DUT, the second detector at the distances (Z22, Y22) or (300 mm, 150 mm). A first point light source (111) emits an incident light ray (130) onto the DUT (110). The incident ray (130) transmits through the DUT (110) and resulted as a transmitted ray (131), and the incident ray (130) reflect from the DUT (110) and results as a reflected ray (132). The first detector (112) and second detector (212) capture an intensity image of the transmitted ray (131) and the reflected ray (132) respectively. The optical system (100) further includes a second point light source (211). The second point light source (211) emits an incident light ray (230) onto the DUT (110). The incident ray (230) transmits through the DUT (110) and resulted as a transmitted ray (231), and the incident ray (230) reflect from the DUT (110) and results as a reflected ray (232). The first detector (112) and second detector (212) capture an intensity image of the reflected ray (232) and the transmitted ray (231), respectively.

A computer can control various aspects of a lens defect inspection system in which the optical system (e.g., (100)) is incorporated. Various aspects of the optical system including controlling movements and positioning of the components (e.g., the light source (111), the DUT (110), and the detector (112) can be implemented by computer software. The computer software can be coded using any suitable machine code or computer language.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and is thus within the spirit and scope thereof.

What is claimed is:

1. An optical system for imaging optical defect, comprising:
an optical object;
a first light source having light emitted from an area of a width of less than 0.4 mm and positioned at a first distance from the optical object, wherein the first light source emits a first incidence light, wherein the first incident light transmitted through the optical object is a first transmitted light, and the first incident light reflected from the optical object is a first reflected light;
a first detector capturing a first intensity image of the first transmitted light and positioned at a second distance from the optical object, wherein the first distance is less than the second;
a second detector capturing a second intensity image of the first reflected light, and positioned at a third distance from the optical object.

2. The optical system according to claim 1, including:
a second light source having light emitted from an area of a width of less than 0.4 mm and positioned at a fourth distance from the optical object, wherein the second light source emits a second incidence light, wherein the second incident light transmitted through the optical object is a second transmitted light, and the second incident light reflected from the optical object is a second reflected light, wherein the first detector capturing a third intensity image of the second reflected light, and the second detector capturing a fourth intensity image of the second transmitted light.

3. An optical system for imaging optical defect, comprising:
an optical object;
a first light source having light emitted from an area of a width of less than 0.4 mm and positioned at a first distance from the optical object, wherein the first light source emits a first incidence light, wherein the first incident light transmitted through the optical object is a first transmitted light, and the first incident light reflected from the optical object is a first reflected light;
a second light source having light emitted from an area of a width of less than 0.4 mm and positioned at a second distance from the optical object, wherein the second light source emits a second incidence light, wherein the second incident light transmitted through the optical object is a second transmitted light, and the second incident light reflected from the optical object is a second reflected light;
a first detector capturing a first intensity image of the first transmitted light and positioned at a third distance from the optical object, wherein the first distance is less than the third distance;
a first detector capturing a second intensity image of the second reflected light.

4. The optical system according to claim 3, including:
a second detector capturing a third intensity image of the first reflected light and positioned at a fourth distance from the optical object;
a second detector capturing a fourth intensity image of the second transmitted light.

5. The optical system according to claim 1, wherein
the detector is configured as a projection screen and an image projected onto the projection screen is captured by a camera.

6. The optical system according to claim 3, wherein
the detector is configured as a projection screen and an image projected onto the projection screen is captured by a camera.

7. The optical system according to claim 1, wherein
the optical system includes a polarizer that polarizes the light.

8. The optical system according to claim 3, wherein
the optical system includes a polarizer that polarizes the light.

9. The optical system according to claim 1, wherein
the optical system includes an aperture stop which is configured an opening to limit the light to within an area of the optical object.

10. The optical system according to claim 3, wherein
the optical system includes an aperture stop which is configured an opening to limit the light to within an area of the optical object.

11. The optical system according to claim 1, wherein
the optical system includes a computer and a software which are configured to control an image acquisition and processing.

12. The optical system according to claim 3, wherein
the optical system includes a computer and a software which are configured to control an image acquisition and processing.

13. A method for imaging optical defect, comprising:
emitting light from a first light source onto an optical object under test having a first and a second surface;
capturing a first intensity image(s) of a transmitted light through the optical object onto a first detector;
capturing a second intensity image(s) of a reflected light from the optical object onto a second detector;
processing the first and second intensity image(s) to characterize a characteristics of the first and second surfaces.

14. A method for imaging optical defect, comprising:
emitting light from a first light source onto an optical object under test having a first and a second surface;
capturing a first intensity image(s) of a transmitted light through the optical object onto a first detector;
emitting light from a second light source onto the optical object;
capturing a second intensity image(s) of a reflected light from the optical object onto the first detector;
processing the first and second intensity image(s) to characterize a characteristics of the first and second surfaces.

15. The method according to claim 13 wherein
the light source is configured as a light emitted from an area of a width of less than 0.4 mm.

16. The method according to claim 15 wherein
the light source is configured as a polarized light.

17. The method according to claim 14 wherein
the light source is configured as a light emitted from an area of a width of less than 0.4 mm.

18. The method according to claim 17 wherein
the light source is configured as a polarized light.

19. The method according to claim 13, wherein
the detector is configured as a projection screen and an image projected onto the projection screen is captured by a camera.

20. The method according to claim 14, wherein
the detector is configured as a projection screen and an image projected onto the projection screen is captured by a camera.
